(19) United States
(12) Patent Application Publication
(10) Pub. No.: US 2013/0144532 A1
(43) Pub. Date: Jun. 6, 2013

(54) IDENTIFICATION OF RESERVOIR GEOMETRY FROM MICROSEISMIC EVENT CLOUDS

(71) Applicants: Michael John Williams, Ely (GB); Bassem Khadhraoui, Marseille (FR)

(72) Inventors: Michael John Williams, Ely (GB); Bassem Khadhraoui, Marseille (FR)

(73) Assignee: SCHLUMBERGER TECHNOLOGY CORPORATION, Sugar Land, TX (US)

(21) Appl. No.: 13/517,007

(22) PCT Filed: Dec. 21, 2010
(86) PCT No.: PCT/IB2010/003318

§ 371 Date: Feb. 20, 2013

Related U.S. Application Data
(60) Provisional application No. 61/288,497, filed on Dec. 21, 2009.

(51) Int. Cl. G01V 1/30; G01V 1/50

(52) U.S. Cl. CPC G01V 1/301; G01V 1/50
USPC 702/11

(57) ABSTRACT

A method for characterizing fracture planes generated during a hydraulic fracturing process, comprises receiving microseismic data from the hydraulic fracturing process and processing a microseismic event cloud from the received microseismic data. This is followed by determining at least one reservoir geometry from the microseismic event cloud. The determination of geometry may consist of determining multiple candidate geometries and probability of each. In some forms of the invention the method may comprise postulating a set of candidate geometries with differing numbers of fracture planes, determining the most probable locations of the postulated fracture planes in each member of the set of candidate geometries and also determining relative probabilities of the candidate geometries in the postulated set. Determining a location of a fracture plane may comprise calculating a number density for each microseismic event, dependent on distance from some possible location of a fracture plane or fracture network. Finding the location of a plane may then be finding the location for which the number density is greatest. The determination of reservoir geometry may be followed by determination of the area of the fracture planes and/or by a prediction of production.

### FIELD OF THE INVENTION

The present invention relates generally to the field of microseismic analysis of Earth formations. More specifically, but not by way of limitation, embodiments of the present invention relate to using microseismic analysis to characterize fractures in the Earth formation which have been created or opened by hydraulic fracturing. Some embodiments of the invention have application to hydrocarbon exploration and production where the hydrocarbon reservoir has natural fractures which can be opened in the course of fracturing, as is the case with some shale reservoirs.

### BACKGROUND OF THE INVENTION

Microseismic measurements can be characterized as a variant of seismics. In conventional seismic explorations a seismic source placed at a predetermined location, such as one or more airguns, vibrators or explosives, is activated and generate sufficient acoustic energy to cause acoustic waves to travel through the Earth. Reflected or refracted parts of this energy are then recorded by seismic receivers such as hydrophones and geophones.

In passive seismic or microseismic monitoring there is no actively controlled and triggered seismic source at a known location. The seismic energy is generated through so-called microseismic events caused by subterranean shifts and changes that at least partially give rise to acoustic waves which in turn can be recorded using suitable receivers. Although the microseismic events may be a consequence of human activity disturbing the subterranean rock, they are quite different from operation of equipment provided as an active seismic source. Relevant background information on instruments and methods for microseismic monitoring can be found for example in the U.S. Pat. Nos. 6,856,575; 6,947,843; and 6,981,550 as well as the published international applications WO 2004/0702424; WO 2005/006020; and the published United States Application no. 2005/01900649 A1.

A specific field within the area of passive seismic monitoring is the monitoring of hydraulic fracturing. Such a hydraulic fracturing operation includes pumping large amounts of fluid to induce cracks in the earth, thereby creating pathways via which the oil and/or gas may flow. After a crack is generated, sand or some other proppant material is commonly injected into the crack to prevent it from closing completely when pumping stops. The proppant particles within the newly formed fracture keep it open as a conductive pathway for the oil and gas to flow from the newly formed fracture into the wellbore.

In the field of microseismic monitoring the acoustic signals generated in the course of a fracturing operation are treated as microseismic events. However, use is made of the information available from the fracturing operation, such as timing and pressure. A well-known example of a set of microseismic data is the Carthage Cotton Valley data, evaluated for example by James T. Rutledge and W. Scott Phillips in: “Hydraulic stimulation of natural fractures as revealed by induced microearthquakes, Carthage Cotton Valley gas field, east Texas”, Geophysics Vol. 68, No 2 (March-April 2003), pp. 441-452. Data relevant for this invention are found in: Rutledge, J. T., Phillips, W. S. and Mayerhofer, M. J., “Faulting induced by forced fluid injection and fluid flow forced by faulting: an interpretation of the hydraulic fracture microseismicity, Carthage Cotton Valley Gas field, Texas”, Bulletin of the Seismological Society of America, Vol. 94, No. 5, pp. 1817-1830, October 2004.

Microseismic monitoring of hydraulic fracturing is a relatively recent, but established technology. In general, such monitoring is performed using a set of geophones located in a vertical well in the proximity of the hydraulic fracturing.

In microseismic monitoring, a hydraulic fracture is created down a borehole and data received from geophones, hydrophones and/or other sensors is processed to provide for monitoring the hydraulic fracturing. Typically the sensors are used to record microseismic wavefields generated by the hydraulic fracturing. By inverting the obtained microseismic wavefields, locations of microseismic events may be determined as well as uncertainties for the determined locations, source mechanisms and/or the like. The set of event locations and the corresponding uncertainties is known as the microseismic event cloud.

In general, the microseismic monitoring is used so that an understanding of the location and site of the fracture can be ascertained. The spread of the fracture through an Earth formation may also be monitored. This data may be used to help manage the fracturing of the Earth formation for hydrocarbon production and or for interpretation/projection of hydrocarbon production through the hydraulically fractured Earth formation.

Current microseismic processing techniques provide for deriving the location and origin time of microseismic events. Recently, microseismic processing has been developed to allow for enhanced real-time decision making capabilities based on received microseismic data. Microseismic monitoring can also be performed with geophones located in multiple wells. In general, the algorithms for processing microseismic data are used to yield a cloud of microseismicity around the hydraulic fracture. Similarities in the waveforms from events at different locations, albeit with the same focal mechanism, may be used to increase the precision of the relative locations of these events. This may provide for increased resolution, similar to that produced by measurements made at a finer temporal resolution.

In the current microseismic processing techniques, algorithms and other processes are used to identify microseismic data, microseisms, associated with the fracture or fractures produced in the microseismic event. As such, the microseismic data is processed so that microseisms associated with the fracture(s) is identified and this data is further processed to make determinations about the fracture(s).

Earth models contain data which characterise the properties of, and surfaces bounding, the geological features which form the earth's sub-surface, such as rock formations and faults. They are used to assist operations occurring in the earth's sub-surface, such as the drilling of an oil or gas well, or the development of a mine.

The domain of applicability of an earth model varies greatly and should be considered on a case by case basis. Some earth models are applicable only in the near vicinity of a particular oil or gas well, or mine. Others may be valid for an entire oil or gas field, or perhaps even over a region such as the North Sea or Gulf of Mexico. An Earth model for a hydrocarbon reservoir may also be referred to as a reservoir model.

The data in an earth model consists of measurements gathered during activities such as the seismic, logging or drilling operations of the oil and gas industry, and of interpretations made from these measurements. The data may be gathered above, on, or below the earth's surface.

As the duration or number of sub-surface operations increases, more data is gathered. This data can be used to amend the relevant earth model, with the aim that it should characterise the geology and properties ever more accurately.

Microseismic data, earth models and the like, may be used in a reservoir model. The reservoir model may itself be used to interpret/manage operations to provide for extraction of hydrocarbons from the reservoir. For example, microseismic data from hydraulic fracturing processes may be fed into the reservoir model to determine how fractures created/expanded during the fracturing impact hydrocarbon recovery. In this way, hydraulic fracturing processes and other wellbore operations may be managed to optimize hydrocarbon recovery. An issue with microseismic data relating to fractures in the Earth formation containing the reservoir that the data is often inconsistent with incorporation into the reservoir model.

### BRIEF SUMMARY OF THE INVENTION

Embodiments of the present invention provide for extracting a reservoir geometry or one or more possibilities for reservoir geometry from microseismic event clouds processed from microseismic data obtained from a hydraulic fracturing process. One embodiment of the present invention provides for identifying the number and location of stimulated fracture planes generated in the hydraulic fracturing process. Embodiments of the present invention, may provide for determining the number and location of stimulated fracture planes generated in the hydraulic fracturing process in real-time.

In certain aspects of the present invention, management/control of the hydraulic fracturing process may be provided based upon the determination of the number and/or location of stimulated fracture planes generated in the hydraulic fracturing process as provided in accordance with an embodiment of the present invention. In embodiments of the present invention, the number of fracture planes and/or the location of the fracture planes are statistically determined for a microseismic event cloud for a hydraulic fracturing operation. In certain aspects, the statistical determination may be used in/applied to a reservoir model. Subsequent analysis of the reservoir may be used with the reservoir model to reevaluate the statistical determination and to provide a further understanding of the geometry of the fracture system.

In an embodiment of the present invention, a method for characterizing fracture planes created during a hydraulic fracturing process is provided, comprising:
receiving microseismic data from the hydraulic fracturing process;
processing a microseismic event cloud from the received microseismic data; and
determining at least one reservoir geometry from the microseismic event cloud.
   Hydraulic fracturing will generally be carried out by pumping fracturing fluid down a wellbore which penetrates the reservoir.

Determining a geometry may comprise determining the number of stimulated fracture planes arising from the hydraulic fracturing process and/or determining the location of at least one stimulated fracture plane arising from the hydraulic fracturing process. The method may comprise determining probability of a geometry and it may comprise determining multiple candidate geometries and probability of each. In some forms of the invention the method may comprise determining the locations of stimulated fracture planes in each member of a set of candidate geometries with different numbers of fracture planes, and determining relative probabilities of the candidate geometries. In some embodiments of the invention the method may comprise determining multiple candidate geometries for several stages of fracturing, the probability of each candidate and then the probability of combinations of the candidates for the various stages of fracturing.

Determining a location of a fracture plane may comprise calculating a probability that each microseismic event lies on a possible location of a fracture plane or fracture network and finding the location for which the probability is greatest. The calculation may be a calculation of a number density for each microseismic event, dependent on distance from some given position. Finding the location of a plane may then be done by finding the location with the highest number density of microseismic events.

In some embodiments of the present invention, the determined fracture planes may be further analyzed to determine a planar area of the derived fracture plane(s). In some embodiments of the invention the method may also comprise making a prediction of production from the reservoir after fracturing. A prediction of production may be useful as providing an assessment of the benefit of the fracturing job without waiting for production to take place. This in turn may be useful in deciding whether or how to fracture other wells penetrating the same reservoir. Matching a prediction to actual production may also be used as a way to confirm the characterization of reservoir geometry or improve it by adjusting the probabilities of candidate geometries.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

The present invention will become more fully understood from the detailed description and the accompanying drawings, wherein:

FIG. 1 is a schematic type illustration of a system for obtaining microseismic data related to hydraulic fracturing;

FIG. 2 is a flow-type illustration of processing microseismic data associated with one or more hydraulic fracturing events;

FIG. 3 shows the projection of error ellipsoids of microseismic events onto a line;

FIG. 4 is an illustration of fracture planes being added to the processed geometry of microseismic data;

FIG. 5 is an illustration of probabilities for fracture plane numbers in a microseismic event cloud;

FIG. 6 is an illustration of fracture planes, shown as bounded quadrilaterals of events in a microseismic event cloud;

FIG. 7 is an illustration of microseismic event clouds following fracturing;

FIG. 8 is a plot of the probabilities of candidate events, and

FIG. 9 is a graph showing a prediction of production and actual production.

### DETAILED DESCRIPTION OF THE INVENTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth herein.

Specific details are given in the following description to provide a thorough understanding of the embodiments. However, it will be understood by one of ordinary skill in the art that the embodiments may be practiced without these specific details.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as a storage medium. One or more processors, which may be one or more computers, may perform the necessary tasks.

In embodiments of the present invention, microseismicity is monitored during hydraulic fracturing operations. The monitoring process may comprise using geophones, hydrophones and/or the like to record microseismic wavefields. By inverting the obtained microseismic wavefields, locations of microseismic events may be determined as well as uncertainties for the determined locations, source mechanisms and/or the like. The set of event locations and the corresponding uncertainties is known as the microseismic event cloud.

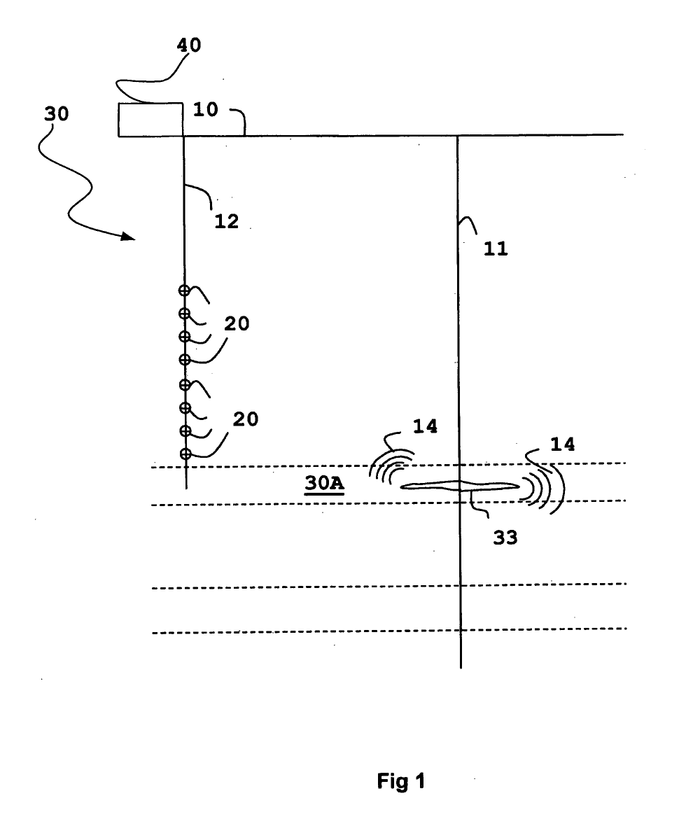

FIG. 1 is a schematic type illustration of a system for obtaining microseismic data related to hydraulic fracturing in accordance with an embodiment of the present invention. As depicted, a monitoring borehole 12 is positioned near a fracturing borehole 11; both the monitoring borehole 12 and the fracturing borehole 11 extending from the Earth's surface 10 through an Earth formation 30. A geophone array 20 may be disposed in the monitoring borehole 12. The geophone array 20 may comprise a plurality of geophones. In some aspects the geophones may comprise three-component geophones. Merely by way of example, the monitoring borehole 12 may be of the order of hundreds of meters from the fracturing borehole and the geophones in the geophone array 20 may be spaced of the order of tens of meters apart.

During hydraulic fracturing, a fluid (not shown) is pumped from the surface 10 into the fracturing borehole 11 so as to cause the Earth formation 30 surrounding the fracturing borehole 11 to fracture, resulting in the generation of a fracture 33 in the Earth formation 30. In the hydrocarbon industry, the fluid may be pumped down the fracturing borehole 11 to provide for the fracturing of a hydrocarbon bearing layer 30A in the Earth formation 30. In such an arrangement where the portion of the Earth formation 30 being fractured is the hydrocarbon bearing layer 30A, the fracture 33 is produced at least partially within the hydrocarbon bearing layer 30A. The purpose of generating the fracture 33 at least partially within the hydrocarbon, bearing layer 30 is to set up production channels in the hydrocarbon bearing layer 30A allowing for flow of the hydrocarbons in the hydrocarbon bearing layer 30A through the Earth formation 30 to the fracturing borehole 11.

In some instances, somewhat dependant on the nature of the layer 30A, more than one fracture 33 may be created or the fracture 33 may connect with natural fractures which are opened by the pressure of pumped fluid. One possibility is that the hydrocarbon bearing layer is a shale. A reservoir which is a shale is generally of low permeability and is stimulated by fracturing in order to achieve production, but incorporates natural fractures which become connected to the newly-formed fracture.

During the fracturing process, acoustic waves 14 are generated by movement in the Earth in response to the fracture 33 and the acoustic waves 14 may propagate through the Earth formation 30 and be detected by the geophone array 20. As such, the geophone array 20 in the monitoring borehole 12 may be used to collect microseismic data related to the hydraulic fracturing procedure taking place in the fracturing borehole 11. The geophones in the geophone array may comprise three-component geophones and may provide directional (three-dimensional) data for the received acoustic waves 14. The data received by the geophone array 20 may be recorded and then processed and/or transmitted to a processor 40 for processing. It is possible, within the scope of the invention, that more than one monitoring borehole 12 may be used and/or that geophones may be located at the surface 10 or at other locations.

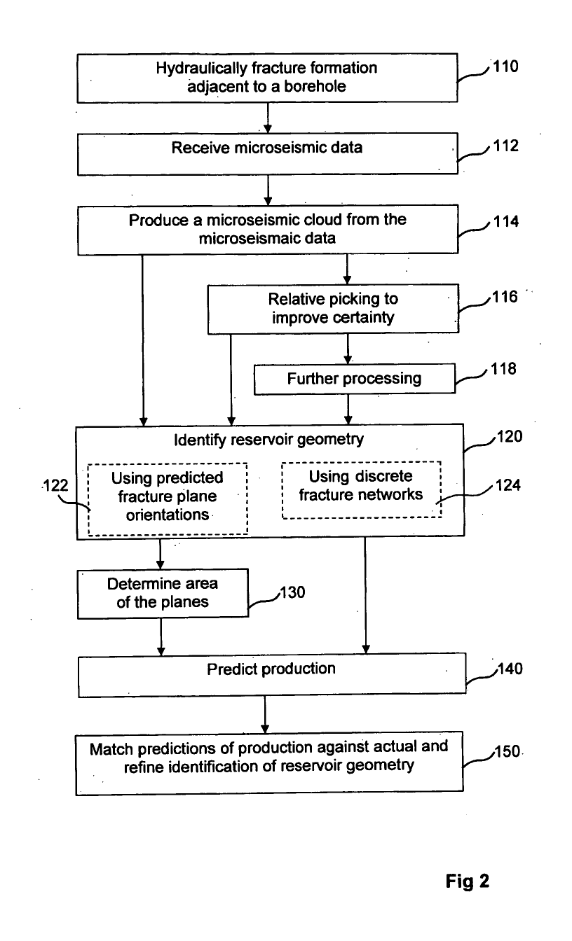

FIG. 2 is a flow-type illustration of processing microseismic data associated with one or more hydraulic fracturing events. In step 110, an earth formation adjacent to a borehole is fractured by pumping fluids into a zone of the borehole generating hydraulic pressure in the zone and fracturing the Earth formation adjacent to the zone. The hydraulic fracturing process may comprise pumping fluids and the like into the wellbore to generate a fracture or plurality of fractures. Often, the fracturing process comprises multi-stage fracturing where hydraulic pressures are built up in multiple locations along the wellbore to create a plurality of fractures along the wellbore, thereby generating multiple fractures in the Earth formation.

In step 112, microseismic data is received by the geophones. The generation of one or more fractures in the Earth formation produces microearthquakes (microseisms) or acoustic emissions associated with either the creation of the fracture or the induced movement of pre-existing fractures, which may comprise natural fractures in the Earth formation and/or natural textural networks in the Earth formation.

In step 114, the microseismic data received by the geophones is processed to determine a presence and location of microseismic events in the data and these microseismic events are then be combined to form the cloud of microseismic events. In the following description the terms microseismic cloud and event cloud may be used interchangeably. During a hydraulic fracturing process, a cloud of microseismicity is generated in the vicinity of the generated hydraulic fracture. Often, the microseismic cloud evolves even after stimulation operations have ended. The locations of the microseisms may be determined using techniques such as Coalescence Microseismic Mapping See, Drew J., Leslie H. D., Armstrong P., and Michaud, G.: AUTOMATED MICROSEISMIC EVENT DETECTION AND LOCATION BY CONTINUOUS SPATIAL MAPPING, Society of Petroleum Engineers (“SPE”) No. 95513, Dallas, Tex., USA, October 2005; Eisner, L., Fischer, T., Jechumtalova, Z., Le Calvez, J., Hainzl, S. and Bouskova, A., NEW ANALYTICAL TECHNIQUES TO HELP IMPROVE OUR UNDERSTANDING OF HYDRAULICALLY INDUCED MICROSEISMICITY AND FRACTURE PROPAGATION, SPE No. 110813, presented at the SPE Annual Technical Conference and Exhibition, Anaheim, Calif., USA, 11-14 Nov. 2007; Michaud, G. and Le Calvez, J. (the entire content of which references is incorporated herein for all purposes).

As indicated at 120 the events in the microseismic cloud are processed to determine fracture geometry. As shown in FIG. 2, input data for the step 120 may be:
(a) The automatically located events determined at step 112 during real-time processing using online wavefield inversion to determine event locations. The location of the events determined this way may have a relatively large location uncertainty. As such, the online processing may only identify major planes associated with microseismic activity. However, the growth of major planes can be determined from such data so that real-time decisions, for example to divert the fracture, can be made.
(b) Events selected by processing of the events cloud, for instance by relative picking as indicated at step 114 typically determined during post-processing of the microseismic data, although techniques may be developed to apply this process in real-time. These events have low location uncertainty and the method may identify the main features of a complex fracture network, along with the extent of the off-plane complexity.
(c) Events from relative picked data that have been further classified at 116, for example into fracture stages (by time), by clustering or by source mechanisms. These data sets consist of relatively few, highly accurate locations.

As shown at step 120 of FIG. 2, the microseismic event cloud or a subset of selected events from that cloud is processed in accordance with the invention, to determine at least one fracture geometry. As will be described below, in some embodiments of the invention determination of geometry may be determination of a number of geometries and their probability, with the geometry comprising the location and number of fracture planes.

Determination of geometry may be done in more than one way. As indicated in FIG. 2, one possibility 122 makes use of predicted orientations while another 124 introduces geological information in the form of a Discrete Fracture Network (DFN) and/or the like. Generally, the more exact the location data input into the process, the more accurate the detailed geometry obtained.

### Interpretation Via Fracture Planes

This approach makes use of a prediction of one or more orientations at which fractures will form. Such a prediction may be provided by a geologist, based on data obtained by well logging before fracturing takes place. It is a prediction of expected orientation(s) of fractures within the rock formation, but is not a prediction of their number nor their location. The potential orientation of the fracture planes may include a range of potential values based on uncertainties and/or include variances to reflect the current information about the field. The preexisting geological understanding may comprise a ‘stereonet’ of fractures interpreted from an FMI log(a log obtained with a Formation Micro Imager logging tool, available from Schlumberger) or preferred fracturing directions interpreted from Sonic Scanner (acoustic scanning tool, also available from Schlumberger).

Interpretation of the event cloud in light of the predicted orientations needs to address the following problem:
Given a set of observed microseismic event locations (x,y,z) and their uncertainty ellipsoids (σₓ, σ_{y}, σ_{z}) and relative likelihoods (magnitudes), calculate the number of planes we are justified in using to describe the geometry that gave rise to the observations, and estimate the best locations of those planes.

In addressing this problem, in accordance with embodiments of the invention it is presumed that an observed microseismic event relates to a plane and only one plane and that planes are not coincident (i.e. the planes are not exactly overlayed, however the planes can cross one-another).

An approach to interpretation which may be used considers each possible number of planes in turn. For each number of planes the most probable position of the planes is calculated, using the event cloud, thus giving one candidate or model geometry. The probabilities of these candidates are then also calculated, allowing the most probable candidates to be identified.

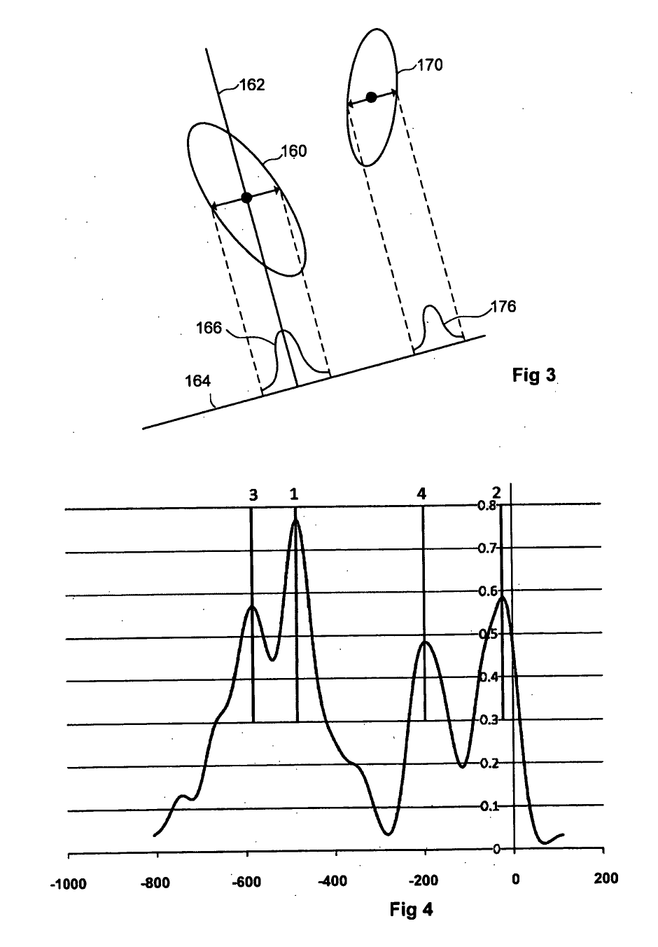

The procedure is as follows and is illustrated by FIG. 3. The predicted fracture orientations are expressed as discrete (θ, φ) pairs (where θ is strike and is dip). A microseismic event Eⱼ at a location (xⱼ,yⱼ,zⱼ) is represented as an error ellipsoid 160 around that location. For an orientation plane defined by (θᵢ, φᵢ), a 3D Hough transform is used to consider the plane 162 defined by (θᵢ, φᵢ) that passes through the microseismic event Eⱼ. The result of the transform provides the minimum distance of that plane to an origin point:

sᵢⱼ(θᵢ,φᵢ)=cos(φᵢ)cos(θᵢ)xⱼ+cos(φᵢ)sin(θᵢ)yⱼ+sin(φᵢ)zⱼ

where s is the plane location relative to an origin.

The projection of the error ellipsoid for the event onto the line 164 perpendicular to the plane 162 and moreover perpendicular to any plane defined by (θᵢ, φᵢ) is calculated. It has the form of a normal distribution shown as curve 166 and is the number density of the event Eⱼ projected onto the line 164. It is normalised such that the event has a total count of 1 along the projection. The event Eⱼ for plane i is thus represented by the following normal distribution:

$${E}_{ij} = \frac{1}{{σ}_{ij} \sqrt{2 π}} exp ( - \frac{{( x - {s}_{ij} )}^{2}}{2 {σ}_{ij}^{2}} ) \qquad ( 2 )$$

As such, the event Eⱼ is completely described by:

Eⱼ={s₁ⱼ±σ₁ⱼ,s₂ⱼ±σ₂ⱼ, . . . ,sᵢⱼ±σᵢⱼ, . . . ,s_{Nj}±σ_{Nj}}

where N is the number of strike-dip pairs describing the discrete plane orientations.

The projection of the error ellipsoid 170 of another event onto line 164 is shown at 176. When there are multiple microseismic events, the number projections such as 166 and 176 cumulate into a continuous curve. The number density of any given microseismic event on an associated fracture plane passing through the origin point is taken as the overall number density projected onto the line 164 which is perpendicular to the fracture plane, i.e. the number density given by the formula (2) above.

For identifying locations, the best location for a plane in the microseismic data is defined as the location with the highest number density of microseismic events. This limits the possible locations for the plane such that the plane must lie between the minimum and maximum value of s for each of the N orientations. In consequence, the n-dimensional search space is reduced to a single dimension by the concatenation of the limits on each line:

X=(s₁ₘₐₓ−s₁ₘᵢₙ)+(s₂ₘₐₓ−s₂ₘᵢₙ)+ . . . +(s₁ₘₐₓ−s₁ₘᵢₙ)+ . . . +(s_{Nmax}−s_{Nmin})

The location of the first plane is found by finding the maximum sum over all locations of x in the search space X. In this processing, the event can appear on one and only one plane, and so the event projection on orientation 1 has no effect to the sum over orientation 2 etc. If the candidate geometry has more than one plane, the next step is to regard the location of the first plane (already determined) as fixed and repeat the above procedure to find the location of the next plane. The procedure is repeated until locations have been determined for all planes in the candidate geometry.

In this way a candidate geometry is worked out for each possible number of planes. After using the above procedure to obtain a “best-fit” solution for each candidate geometry, the next step is to find and compare the probabilities of the individual candidate geometries.

For a candidate geometry with one plane, the probability is calculated using Bayes Theorem integrated over all possible locations of the plane:

$$P ( E \vert S ) = {\int }_{{X}_{m i n}}^{{X}_{ma x}} P ( \vert S = x ) P ( S = x ) d x$$

where S is the location of the plane. Since there is no initially preferred location for the plane:

$$P ( S = x ) = \frac{1}{{X}_{ma x} - {X}_{m i n}}$$

By noting that the integral can be written as the mean multiplied by the limits, the function may be rewritten as:

$$\begin{matrix}P ( E \vert S ) = \frac{1}{{X}_{m ax} - {X}_{m i n}} {\int }_{{X}_{m i n}}^{{X}_{ma x}} P ( E \vert S = x ) d x \\ = \frac{{X}_{m ax} - {X}_{m i n}}{{X}_{ma x} - {X}_{m i n}} 〈 P ( E \vert S = x ) 〉 \\ = 〈 P ( E \vert S = x ) 〉\end{matrix}$$

If the candidate geometry has more than one plane, the principle is the same but the formula is more complex. For two planes denoted F₁, F₂ the formula becomes the one-dimensional integral.

$$P ( D \vert {F}_{1} , {F}_{2} ) = {\int }_{{x}_{min}}^{{x}_{max}} P ( D , {x}_{2} \vert {F}_{1} , {x}_{1} , {F}_{2} ) d {x}_{2} = {\int }_{{x}_{min}}^{{x}_{max}} P ( D \vert {F}_{1} , {x}_{1} , {F}_{2} , {x}_{2} ) P ( {x}_{2} \vert {F}_{2} ) d {x}_{2}$$

The plane F₂ is located at some unknown distance x₂ measured from the origin, along the normal to the plane, between the first and last microseismic events (corresponding to Xₘᵢₙ and Xₘₐₓ respectively). The position of the plane F₁ is considered fixed at x₁. or alternatively the integral can be calculated over both planes, in which case the integral becomes a double integral in dx₁ and dx₂.

During the calculation of the integral, the best location of the plane is stored and this is added to the existing multi-plane solution, which is then used in evaluating the integral for the addition of the subsequent plane.

### Example

As an example, a synthetic event cloud of 284 event locations was analysed as above to determine geometry. A single strike dip pair (90°, 0°) was used as predicted orientation. The error ellipsoids were projected onto a single line and the cumulation of their number density is the curve shown in FIG. 4 (the projected width of the error ellipsoids was set at 25 and it can be seen that the horizontal axis in FIG. 4 extends over a range of about 1000). The probabilities for solutions with one plane, two planes and so on up to 94 planes are plotted as a graph which is FIG. 5. It can be seen that the solutions with 2, 3, 4 and 5 planes all have similar probability, and that the probability for 6 planes is not much lower.

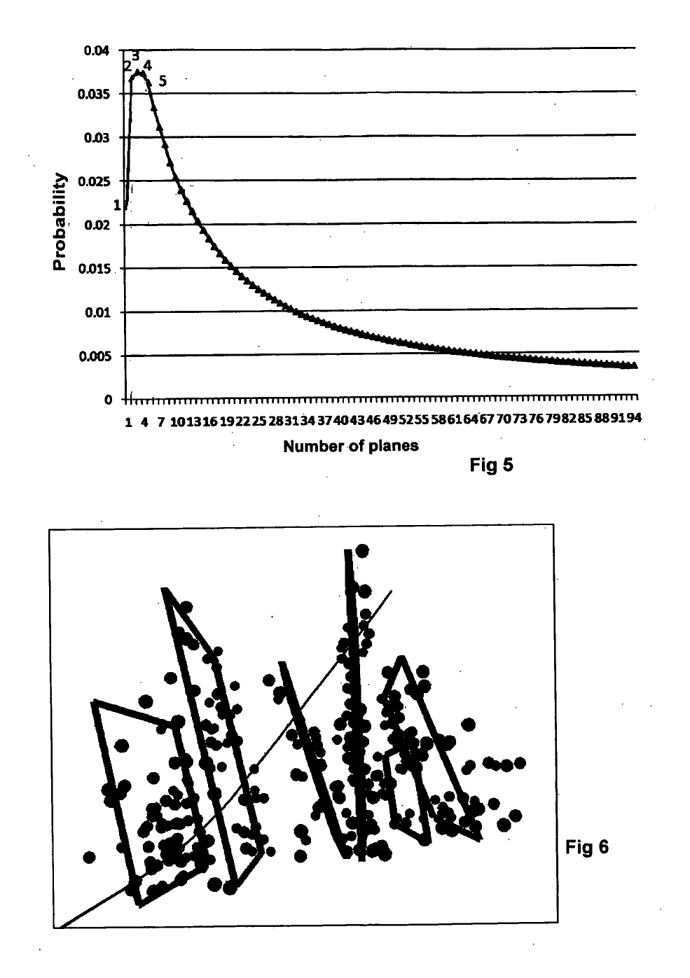

Calculation with several strike, dip pairs was also carried out and the candidate geometry with six large fracture planes, shown as bounded quadrilaterals, is illustrated as FIG. 6.

### Geostatistical Interpretation Via DFNs

In another approach to identifying reservoir geometry, indicated 124 in FIG. 2, information about the reservoir formation which is subjected to hydraulic fracturing and from which the microseismic data is gathered is used to generate multiple discrete fracture representations using a Discrete Fracture Network (DFN) simulator—such as that provided in Petrel (simulation software available from Schlumberger).

The DFN representations are clustered according to a connectivity analysis. In this connectivity analysis overlapping fractures are considered to be connected and for each DFN, the connected sets represent potential flow paths for fluid during hydraulic fracturing. The microseismic events are processed using Radon transforms to project onto the features of the DFN and determine the distance to each cluster, noting that this distance depends on both the orientation and extent of the individual planes within each cluster (this is analogous to projection onto planes in step 122 described above). The number density of the event locations on the feature is used to determine the goodness-of-fit Each connected set of features is examined to find the best-fit (highest number density of microseismic events). All connected sets are tested, and there is no initial preference for any particular set, and so the mean result can be used for model comparison as with planes in step 122. The best connected set is kept in the calculation and the procedure is repeated one or more times to look for other connected set(s) to add to the solution.

This approach can be applied very rapidly since the features are explicitly defined and the search space is thus relatively small. This means that many DFN representations can be used to build up a geostatistical picture of potential flow geometries. The generation of the DFNs can be made prior to the job and constrained to the available geological information. The potential effect of activating different DFN realizations can be investigated using geomechanical-fluid flow coupled simulations, for example ECLIPSE-VISAGE, (simulation software available from Schlumberger) prior to the hydraulic fracturing procedure, therefore, allowing DFN-based predictions of performance to be made during the fracturing job in real-time. Another possibility would be to include an initial step of examining the DFN representations with a complex-fracture simulator such as Mangrove (also a Schlumberger product), to identify and select fracture geometries that are consistent with the material balance of the stimulation treatment.

The use of DFNs in this way may allow interpretation of geometries that indicate possible aseismic responses, and as such might provide useful additional input to processing microseismic data using both seismic and aseismic slip.

Polygons and Area from Plane Solutions

Once a reservoir geometry with location of the planes has been determined, using the methods described above, a possible next step in accordance with an embodiment of the present invention is to estimate the area of the planes. This is denoted 130 in FIG. 2. The area of the fracture planes may be used to derive an equivalent fracture polygon for the fracture plane. The fracture plane area, the equivalent fracture polygon and/or the like may, in aspects of the present invention, be used in geomechanical and fluid flow models.

The minimum planar area of the derived fracture plane may be determined by projecting all of the points i.e. microseismic events associated with the plane onto the plane and calculating the minimum convex hull encompassing the points; this is known as the negative α-hull technique. The maximum planar area of a derived fracture plane may be considered as the sum over all nearest-neighbour triangles, determined by Delaunay Triangulation. Additional estimates, more suited to the approximations made in geomechanical and fluid flow simulations, may include the bounding convex quadrilateral method, shown in FIG. 6 above. Other definitions of the extracted shape are possible, to summarize the results, the choice is driven by the specific application (i.e. the model that will make use of the summary).

In the case of DFN-based interpretation, the DFN clusters provide the fracture area. The consideration of many realizations provides the spread of minimum to maximum contacted area.

### Example Including Production Prediction

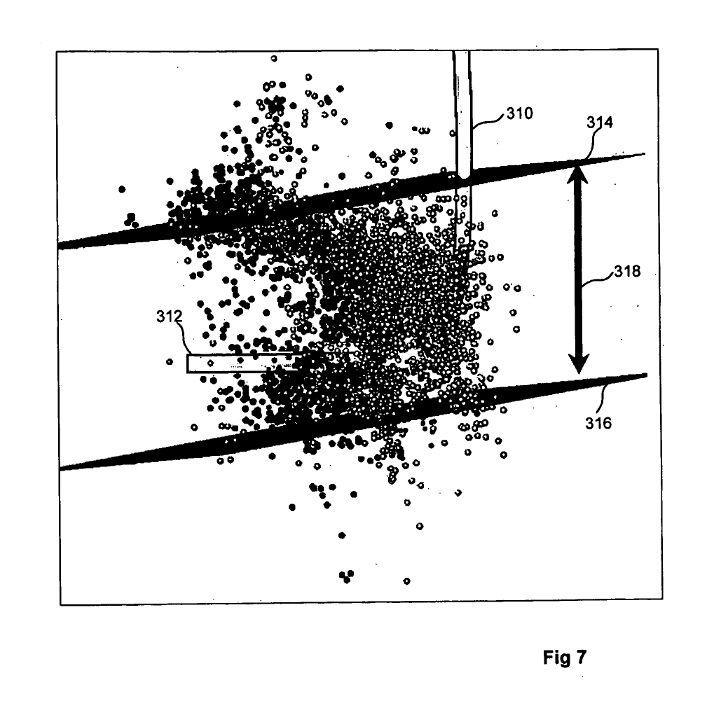

The following example illustrates a determination of reservoir geometry when there are multiple fracturing stages. A wellbore penetrating a gas reservoir was subjected to two fracturing treatments with a period of production between the two. Each treatment consisted of two fracturing stages. FIG. 7 generally illustrates the microseismic event clouds of the two treatments. The wellbore 310 has a horizontal section 312 at its lower end. The events for the first fracturing treatment are shown as filled circles while the events for the later treatment are shown as open circles. The microseismic event clouds for the separate stages of each treatment were recorded separately but are not shown separately in FIG. 7. The planes 314 and 316 which are shown are the top and bottom of the producing interval 318.

The data for each of the four stages was interpreted individually, using predicted orientations as described above and making an assumption that for each stage of fracturing there were at most three fracture planes. Consequently for each of the four fracturing stages three best-fit candidate geometries with one, two or three fracture planes respectively were calculated together with the relative probabilities for each of the candidate geometries.

In a subsequent stage of calculation, the probabilities for combinations of numbers of fracture planes were calculated. The notation used writes the probability that treatment stage 1 has a geometry consisting of 1 fracture plane as P(S1 has 1 Frac).

The relative probabilities for each of the candidate geometries were normalized so that the probability of each treatment stage producing a fracture geometry is 1. So,

P(S1 has 1, 2, 3 fracs)=P(S1 has 1 Frac)+P(S1 has 2 Fracs)+ . . . +P(S1 has 3 Fracs)=1

As each fracture treatment stage was considered independent, any set of planes from the interpretation of stage 1 could be combined with any set of planes from the interpretation of stage 2 etc. The probability of a particular combination was constructed using AND in the usual form for independent probabilities:

P(Stage 2 has 2 Fracs∩Stage 1 has 3 Fracs)=P(Stage2 has 2 fracs)*P(Stage 1 has 3 fracs).

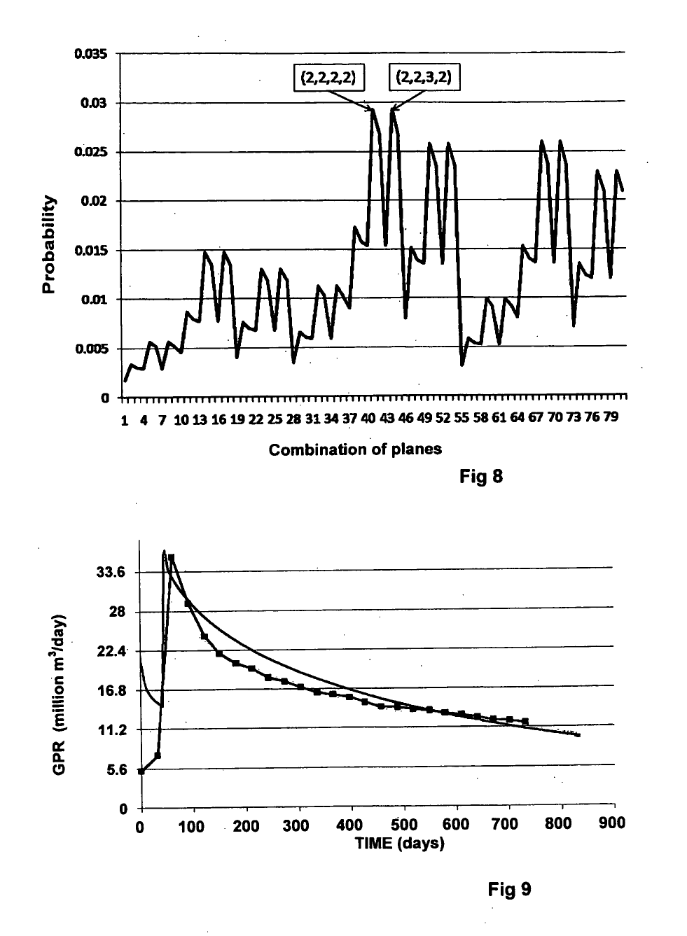

Since there were four stages each with 3 possible fracture geometries, there were 81 possible combinations in total. The relative probabilities for all of these combinations were calculated and are shown in FIG. 8. The most likely cases are indicated: one is 2 fractures in each stage; and the other is 2 fractures for three of the stages with 3 fractures for the first stage of the second treatment.

For each of the 81 candidate geometry combinations, the areas of the fractures were calculated at described above and as indicated at 130 in FIG. 2. It will be appreciated that a separate step of determining areas would be needed if DFNs had been used as at step 124 because (as mentioned above) the DFN clusters provide the fracture area. Next, as indicated at 140′ in FIG. 2, a prediction of production was made. For this, a gas production rate (GPR) was determined for the area of each candidate geometry using reservoir simulator software. An overall forecast of production was then made by multiplying the probability for each combination of candidate geometries by the production rate for that combination and summing the products, in accordance with the formula:

$$〈 GPR 〉 = {\sum }_{i = 1}^{n} {P}_{i} ( {geometry}_{i} ) {GPR}_{i}$$

FIG. 9 shows the prediction made in this way and also shows recorded production from the well.

A further possibility, indicated as step 150 in FIG. 2 is to use the actual production data from the well to refine the interpretation of the microseismic data. A production prediction is calculated for each combination of candidate geometries. Those which match actual production can then be regarded as more probable and those which do not match production can be ruled out or given a lower probability.

Working with Outliers—Mis-Picks, Poor Coverage and Stimulated Zones

Sometimes a fortuitous correlation of noise on a number of traces can result in an event location that does not correspond to a microseismic event. Unfortunately it is also the case that legitimate microseismic events can occur that cannot be related to planes (for example an event that does not occur on a large-scale plane; or events occurring on a plane that only provides a few (i.e. less than about 4) microseismic events—a plane fit to data with location errors is not possible with less than 4 points (if the location errors were zero then 3 points would be sufficient). This second class of events may form useful structure for production geometry, particularly if they constitute small scale complexity in the vicinity of a large scale fracture. Both situations constitute outliers for the present process.

In some embodiments, the outliers could be handled in full by considering combinations of the data as outliers and recomputing the answer, building up a set of answers subject to different outliers etc. However, this may presents a huge combinatorial problem and is impractical for even a few hundred event locations. Instead, in embodiments of the present invention the following approximation may be used:

The event data is binned (i.e. allocated to a set referred to as a bin) according to the plane on which the event has the largest density projection. As such, each bin will contain both events relating to the plane and those that are outliers.

Each bin is considered as containing count-rate data consisting of a combination of useful, fracture complexity, and randomly distributed ‘mis-pick’ events. Since the fracture complexity is useful in the vicinity of the plane, this situation can be modeled by a Poisson distribution, with the peak located at the plane, S; the peak having a width λ and a fraction U of events contributing to the signal, with (1-U) being random noise. As such the following relationship may be provided:

$$P ( {s}_{ij} \vert {σ}_{ij} , S , λ , U ) = [ \frac{U}{\sqrt{2 π ( {λ}^{2} + {σ}_{ij}^{2} )} } exp ( - \frac{{( {s}_{ij} - S )}^{2}}{2 ( {λ}^{2} + {σ}_{ij}^{2} )} ) + ( 1 - U ) ]$$

where there are two unknowns, λ and U, which may be estimated from:

$$P ( λ , U \vert \{ {s}_{ij} \} , I ) ∝ P ( \{ {s}_{ij} \} \vert λ , U , I ) P ( λ , U \vert I ) = \frac{{\prod }_{j} [ \frac{U}{\sqrt{2 π ( {λ}^{2} + {σ}_{ij}^{2} )}} exp ( - \frac{{( {s}_{ij} - S )}^{2}}{2 ( {λ}^{2} + {σ}_{ij}^{2} )} ) + ( 1 - U ) ]}{( {λ}_{ma x} - {λ}_{m i n} ) ( {U}_{m ax} - {U}_{m i n} )}$$

Here the data errors, σᵢⱼ, and location of the plane, S, have been incorporated in the background information, I, to reduce clutter. (Uₘₐₓ-Uₘᵢₙ may be taken to be 1, since somewhere between none and all of the data are noise; similarly, λₘₐₓ can be limited to the bin width and λₘᵢₙ is positive. Maximizing this relation then gives an estimate of the zone around the fracture, λ, and the level of random noise, (1-U). In a multiple plane solution, the planes can then be compared for their near-plane zones and noise levels.

In accordance with embodiments of the present invention, as detailed above, microseismic data from a hydraulic fracturing process may be processed using existing geological data to determine the number, location, planar area and/or the like of stimulated fractures resulting from the hydraulic fracturing process.

The foregoing describes how microseismic event locations having uncertainties may be processed and understood. Moreover, the described methods show how, in accordance with an embodiment of the present invention, the uncertain microseismic event clouds from a hydraulic fracturing process may be statistically analyzed and a statistical representation of the generated fractures may be determined. In course, in accordance with an embodiment of the present invention, the statistical representation may be input into a reservoir model and extraction of hydrocarbons may be modeled.

Using the statistical analysis of the present application, the relative probability of the 1-plane, 2-plane, 3-plane etc. interpretations of the microseismic data can be analyzed and a complete set of relative probabilities determined. In certain aspects where the maximum of the ‘Number of planes’ curve is much more probable than the other interpretations, an unambiguous result may be achieved. In the more general case, the maximum of the ‘Number of planes’ curve has a similar probability to its neighbours, the result is ambiguous. However, in an embodiment of the present invention, because the relative probability of the different interpretations is calculated, any reservoir representation for the reservoir model can be constructed by a probability-weighted sum. For example, the following relationship can be determined and input into the model:

fracture_area_estimate=SUM(Pᵢ*fracture areaᵢ)

where Pᵢ is the probability of the i-plane solution and fracture areaᵢ is the sum of the fracture areas for that case.

Additionally, in an embodiment of the present invention, the uncertainty in the estimate of the fracture area can be determined as:

std_dev of fracture area=SQRT(SUM{(fracture_areaᵢ−fracture_area_estimate)²Pᵢ}

assuming a normal distribution for fracture area. In the more general case (non-linear cases, maximum entropy approaches may be used, such as described in “Maximum Entropy Application Methods and Systems”, attorney docket number 94.0212, U.S. patent application Ser. No. 12/552,159, the entire disclosure of which is incorporated herein by reference.

It will be appreciated that embodiments of the present invention, may provide for handling a number of interpretations of the number of fracture planes, the location of the fracture planes, the area of the fracture planes and/or the like consistently and carrying the interpretations forward for use in a reservoir interpretation.

While the principles of the disclosure have been described above in connection with specific apparatuses and methods, it is to be clearly understood that this description is made only by way of example and not as limitation on the scope of the invention.

What is claimed is:

1. A method for characterizing fracture planes generated during a hydraulic fracturing process, comprising:
receiving microseismic data from the hydraulic fracturing process;
processing a microseismic event cloud from the received microseismic data; and
determining at least one reservoir geometry from the microseismic event cloud.

2. The method according to claim 1 which comprises determining at least one probability of a reservoir geometry from the microseismic event cloud.

3. The method according to claim 1 which comprises determining a plurality of reservoir geometries from the microseismic event cloud together with a probability of each reservoir geometry.

4. The method according to claim 1, wherein the step of determining the reservoir geometry from the microseismic event cloud comprises determining the number of stimulated fracture planes generated by the hydraulic fracturing process.

5. The method according to claim 1, wherein the step of determining the reservoir geometry from the microseismic event cloud comprises determining a location of at least one stimulated fracture plane generated by the hydraulic fracturing process.

6. The method according to claim 5 which comprises
determining the locations of stimulated fracture planes in each member of a set of postulated candidate geometries with different numbers of fracture planes, and
determining relative probabilities of the candidate geometries.

7. The method according to claim 5 wherein determining a location of a fracture plane comprises determining a location at which a maximum number of microseismic events are associated with the fracture plane or a fracture network.

8. The method according to claim 5 wherein determining a location of a fracture plane comprises calculating a probability that each microseismic event lies on a possible location of a fracture plane or fracture network and determining the location for which the probability is greatest.

9. The method according to claim 1, further comprising
identifying at least one potential orientation of fracture planes for stimulated fractures resulting from the hydraulic fracturing process from data obtained prior to the hydraulic fracturing process,
calculating a number density of each microseismic event on a line perpendicular to the orientation and
selecting the location with the highest number density of microseismic events as the location for a fracture plane.

10. The method according to claim 1, wherein the step of determining a reservoir geometry from the microseismic event cloud comprises
generating multiple representations of fracture networks
calculating a number density of each microseismic event dependent on distance from each fracture network, and
selecting the fracture network with the highest number density of microseismic events.

11. The method of claim 1 wherein the step of determining a reservoir geometry from the microseismic event cloud comprises
generating multiple representations of fracture networks
clustering the fracture networks according to a connectivity analysis in which overlapping fractures are considered to be connected
calculating a number density of each microseismic event dependent on distance from each fracture network cluster, and
selecting the fracture network cluster with the highest number density of microseismic events.

12. The method according to claim 1, further comprising determining a planar area of the generated fracture plane(s).

13. The method according to claim 1, further comprising predicting production through the fractures.

14. The method according to claim 12, further comprising comparing predicted production to actual production and then adjusting the determination of reservoir geometry to improve the match.

15. A computer program comprising code which, when run on a computer causes the computer to perform the method of claim 1.

16. A computer readable medium having a computer program according to claim 15 stored thereon.
